(19) United States
(12) Patent Application Publication
(10) Pub. No.: US 2012/0279424 A1
(43) Pub. Date: Nov. 8, 2012

(54) DIRECT BATCH AGGREGATE VACUUM SATURATION FOR MIXING CONCRETE

(75) Inventors: Frank Russell Fork, Pataskala, OH (US); Steven Matrisciano, Sylvania, OH (US); Basil Postupack, Rock Hill, SC (US)

(73) Assignee: Boral Stone Products LLC

(21) Appl. No.: 13/100,717

(22) Filed: May 4, 2011

(51) Int. Cl. C04B 20/10; B28C 7/04

(52) U.S. Cl. 106/672; 366/19

(57) ABSTRACT

An apparatus for producing lightweight aggregate concrete utilizing fully saturated aggregate particles includes a vacuum vessel that discharges substantially directly into a concrete mixer that combines the aggregates with quantities of cement and water to create a batch of lightweight aggregate concrete. The vacuum vessel receives a supply of non-saturated lightweight aggregates from a bulk supply bin. A pump evacuates the air from the vessel until a desired vacuum level is attained, which evacuates air from the pores and interstitial spaces within the aggregate particles. The volume of water needed to fully saturate the aggregates within the vessel is fed into the vessel to create fully saturated aggregates that are subsequently discharged into the concrete mixer. The second volume of water needed to hydrate the cement is added to the vessel to flush out the vessel and be discharged into the concrete mixer to produce the batch of concrete.

### TECHNOLOGICAL FIELD

Embodiments of the present invention relate generally to the batch mixing of cementitious concrete, and, more particularly, to the vacuum saturation of lightweight aggregate for direct discharge into a concrete mixer to produce a batch of lightweight cementitious concrete.

### BACKGROUND

Cementitious concrete may be produced by mixing together cement (e.g., Portland cement), aggregate, and water. The concrete mixture may then be placed into a form while the concrete mixture cures into a hardened mass to create the desired finished product, such as, for example, a road, a bridge, or a building. Many different concrete mixtures are available to provide desired strengths, cure times, and/or specific weights, as well as many other properties. One such concrete mixture can utilize lightweight aggregates, such as expanded clay, expanded slate, expanded shale, slag, pumice, Perlite, lava rock, and/or other aggregate materials that have a density below about sixty pounds per cubic foot. These lightweight aggregate materials have numerous interstitial spaces, and are thus more desirably porous than normal weight aggregates. However, lightweight aggregate materials are capable of absorbing water from the concrete mixture, which can prevent proper hydration of the cement. Accordingly, such lightweight aggregates are typically fully saturated with water before being added to the concrete mixer. As a result, the water within the saturated lightweight aggregate does not contribute to the water needed to hydrate the cement.

Lightweight aggregates can be pre-saturated in a variety of ways, including the non-limiting examples of sprinkling methods, thermal saturation methods, or vacuum saturation methods. Sprinkling is accomplished by sprinkling water onto a pile of lightweight aggregates, usually for days prior to being utilized in a concrete mixture. Such a sprinkling process requires substantial quantities of water because it creates runoff and evaporation. Additionally, the sprinkling method is not completely effective in fully saturating all of the aggregates within the pile. Indeed, lightweight aggregates pre-hydrated by sprinkling methods typically need to have a continued application of water, including during the conveyance of the aggregate to the batch processing plant. Thermal saturation requires heating the lightweight aggregates and then immersing the heated aggregates in water. Aggregate particles subjected to thermal quenching absorb significantly more moisture than particles that are sprinkled for a full day. Vacuum saturation consists of placing the lightweight aggregates into a tank and then drawing a vacuum on the tank while adding water to the tank. Vacuum saturation may provide full saturation in about thirty minutes.

Most known thermal saturation and vacuum saturation methods can accomplish full saturation of lightweight aggregate particles in a significantly shorter time than the sprinkling process. However, these methods are typically done by the aggregate supplier and the saturated particles are then transported to the concrete batch plant. The requirement of transporting the saturated lightweight aggregates necessitates storage of the pre-saturated aggregates, which, in turn, results in a loss of moisture from the porous aggregate particles unless the saturated aggregate is stored in a watering bunker, which then adds further cost and inefficiencies to the process of producing lightweight aggregate concrete. As such, lightweight aggregates require continued watering prior to delivery to the concrete batch plant. Furthermore, lightweight aggregates, particularly fine lightweight aggregates that have been pre-hydrated, become difficult to convey and charge to the concrete mixer. Additionally, hydrated lightweight aggregates are heavier than non-hydrated lightweight aggregates and present additional shipping costs from the aggregate supplier to the concrete batch plant.

Despite the existence of a variety of known vacuum saturation processes, there remains a need in the art to provide a process for producing lightweight aggregate concrete that provides improved pre-hydration results with enhanced economies by reducing both waste and shipping costs.

### BRIEF SUMMARY

It is an object of various embodiments of the present invention to provide a method of producing lightweight aggregate concrete effectively with fully saturated or substantially fully saturated aggregate.

It is another object of various embodiments of the present invention to provide an apparatus for producing lightweight aggregate concrete with fully saturated or substantially fully saturated lightweight aggregate.

It is a feature of various embodiments of the present invention that the lightweight aggregate may be saturated by a vacuum saturation process.

It is another feature of various embodiments of the present invention that the fully saturated or substantially fully saturated lightweight aggregate may be conveyed directly into a concrete mixer to be combined with cement and water to produce lightweight aggregate concrete.

It is an advantage of various embodiments of the present invention that the fully saturated or substantially fully saturated lightweight aggregate may be discharged directly from the vacuum vessel into the concrete mixer for the production of a lightweight aggregate concrete mixture.

It is another advantage of various embodiments of the present invention that the saturated lightweight aggregate may not require substantial transport from an aggregate supplier or storage in a watering bunker until utilization thereof.

It is yet another feature of various embodiments of the present invention that the vacuum saturation of the lightweight aggregate may be accomplished immediately prior to the aggregate being placed into the concrete mixer for the production of a lightweight aggregate concrete mixture.

It is a further feature of various embodiments of the present invention that the amount of water needed to fully saturate a predetermined supply of lightweight aggregate may be defined empirically.

It is still another object of various embodiments of the present invention that the process step of fully saturating lightweight aggregate prior to being discharged into a concrete mixer may include a predetermined quantity of additional flush water to remove the aggregate from the vacuum vessel.

It is still another advantage of various embodiments of the present invention that the predetermined quantity of additional flush water may correspond generally to the volume of water that may be needed to produce the batch concrete mixture.

It is a further advantage of various embodiments of the present invention that the life of a fresh batch of lightweight aggregate concrete may be extended as adequate water is provided for the concrete batch and for fully saturating the lightweight aggregate.

It is a further feature of various embodiments of the present invention that tighter tolerances on the water to cement ratio for a given batch of lightweight aggregate concrete may be maintained with assurances of complete saturation of the lightweight aggregate.

It is still another advantage of various embodiments of the present invention that the ultimate durability of the cured concrete may be enhanced due to an improved interfacial transition zone bonding between the cement and the lightweight aggregate.

It is yet another advantage of various embodiments of the present invention that the storage infrastructure for maintaining water saturation of lightweight aggregates of known prior art processes may be eliminated, resulting in lower material costs to produce lightweight aggregate concrete.

It is still a further advantage of various embodiments of the present invention that the concrete temperature during the curing phase may be reduced by limiting the conversion of shear energy to heat.

It is yet another advantage of various embodiments of the present invention that the lightweight aggregate may be shipped from an aggregate supplier in a dry state to reduce shipping costs associated with the production of lightweight aggregate concrete.

It is yet another object of various embodiments of the present invention to provide a method of producing lightweight aggregate concrete that includes the steps of (1) providing a supply of non-saturated lightweight aggregate into a vacuum vessel, (2) calculating the first volume of volume of water required to fully saturate the supply of lightweight aggregate in the vacuum vessel and the second volume of water needed to produce a batch of lightweight aggregate concrete, (3) drawing a vacuum on the vacuum vessel to draw air from the vacuum vessel and from the interstitial spaces within the lightweight aggregate, (4) metering water into the vacuum vessel until the first volume of water has been attained, (5) directly discharging the fully saturated or substantially fully saturated lightweight aggregate into a concrete mixer with a predetermined supply of cement and the second volume of water, and (6) mixing the components until a batch of lightweight aggregate concrete is produced for discharge from the concrete mixer.

It is still another feature of various embodiments of the present invention that the second volume of water may be used to flush the vacuum vessel from any remaining lightweight aggregate after the direct discharge thereof to the concrete mixer.

It is yet another feature of various embodiments of the present invention that the water may not need to be metered into the vacuum vessel until the proper level of vacuum has been reached within the vacuum vessel.

It is still a further feature of various embodiments of the present invention that the first volume of water may be calculated from the volume, density, and moisture content of the non-saturated lightweight aggregate input into the pressure vessel.

It is s further object of various embodiments of the present invention to provide an apparatus for producing lightweight aggregate concrete that includes a vacuum vessel positioned to received a predetermined quantity of non-saturated lightweight aggregate, a vacuum pump for evacuating air from the vacuum vessel (including air from the interstitial spaced within the lightweight aggregate), a water supply to meter a flow of a first volume of water into the vacuum vessel to fully saturate the lightweight aggregate within the vacuum vessel, and a concrete mixer positioned to receive the fully saturated or substantially fully saturated lightweight aggregate directly from the vacuum vessel to be combined with a predetermined quantity of cement and a second volume of water to create a lightweight aggregate concrete mixture for discharge from the concrete mixer.

It is yet a further feature of various embodiments of the present invention that the supply line for inputting the first volume of water into the vacuum vessel may be sized to avoid drawing air into the vacuum vessel and, thus, reduce the vacuum level.

The foregoing and other objects, features, and advantages of various embodiments of the present invention will appear more fully hereinafter from a consideration of the detailed description that follows.

### BRIEF DESCRIPTION OF THE DRAWING

The accompanying drawing incorporated herein and forming a part of the specification, illustrates several aspects of various embodiments of the present invention and together with the description serves to explain certain principles of the various embodiments. In the drawing:

FIG. 1 is a schematic diagram of the apparatus for producing a batch of lightweight aggregate concrete according to the principles of various embodiments of the present invention.

### DETAILED DESCRIPTION

Various embodiments of the present invention will now be described more fully hereinafter with occasional reference to the accompanying drawing, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

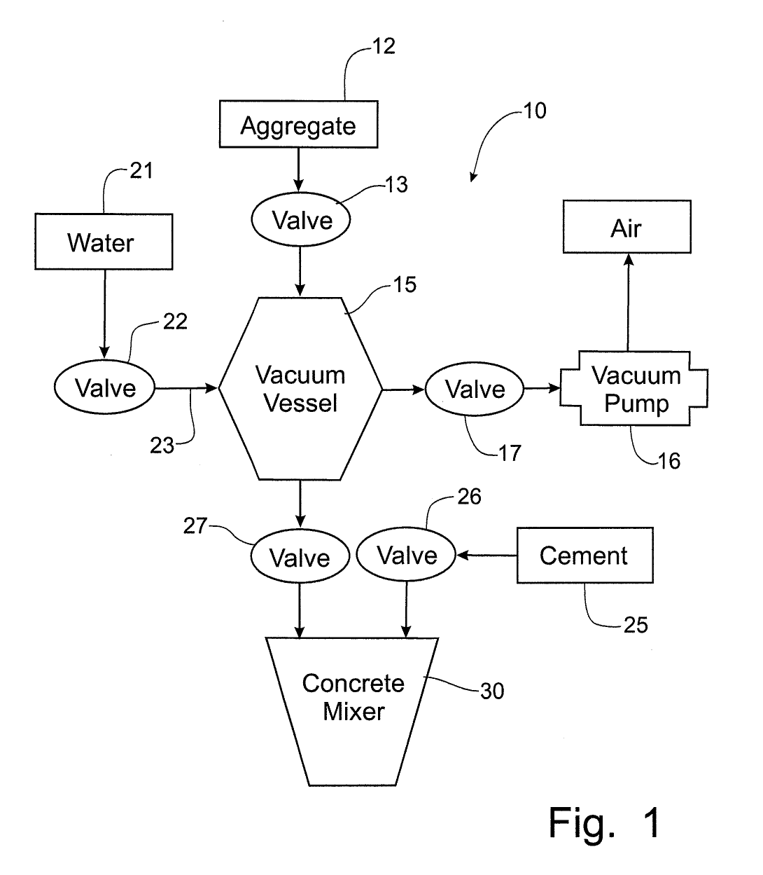

Turning to FIG. 1, the apparatus 10 and the process for producing a batch of lightweight aggregate concrete according to the principles of various embodiments of the present invention may best be seen. According to various embodiments, lightweight aggregate suitable for the production of lightweight aggregate concrete may be shipped from an aggregate supplier and retained in a bulk storage bin 12 in a non-saturated state. In certain embodiments, such lightweight aggregate material may include the non-limiting examples of expanded clay, expanded slate, expanded shale, slag, pumice, Perlite, lava rock, other aggregate materials having a density below about sixty pounds per cubic foot, and combinations thereof. The density and moisture content of the non-saturated lightweight aggregate material may be tested and represent known parameters of the stored aggregate material. Shipment of the non-saturated lightweight aggregate, as well as storage thereof, is simpler and less expensive than known processes for manufacturing concrete because the aggregate according to various embodiments is not saturated with water and does not have to be retained in a saturated state before being utilized.

According to various embodiments, a vacuum vessel 15 is configured to receive a predetermined quantity of a non-saturated lightweight aggregate from the bulk storage bin 12. In certain embodiments, the vacuum vessel 15 may have a pre-established volume that is greater than the volume of the aggregate needed for any particular batch of concrete to be produced in the concrete mixer 30. In other embodiments, the vacuum vessel 15 may be sufficiently large so as to receive the largest volume of lightweight aggregate necessary for a batch of concrete produced by a concrete mixer 30 (as described in further detail below). In any of these and still other embodiments, a valve or metering device 13 may be included to control the flow of the non-saturated lightweight aggregate into the vacuum vessel 15 to establish the predetermined quantity of the aggregate in the vacuum vessel 15.

According to various embodiments, after loading the non-saturated lightweight aggregate into the vacuum vessel 15, a vacuum pump 16 may be activated to draw the air from the vacuum vessel 15 through a valve 17 until a desired pressure level is attained, at which point the valve may be closed to hold the vacuum level in the vacuum vessel 15. Those skilled in the art will recognize that the attainment of the desired vacuum level within the vacuum vessel 15 is operable to withdraw or evacuate the air from the interstitial spaces within the lightweight aggregate particles. In any of the various embodiments, with regard the use of the vacuum vessel 15, it should also be appreciated that the size of the vacuum vessel 15 should additionally and/or alternatively also be large enough such that that a water level (not shown, but described in detail below in the context of supplying water from a supply source 21) within the vessel, after metering water into the same, does not reach the suction line for the vacuum pump 16.

Based on the density, volume, and moisture content of the lightweight aggregate material within the vacuum vessel 15, a first volume of water needed according to various embodiments to fully saturate the lightweight aggregate within the evacuated vacuum vessel may be calculated by any of a variety of known methods. Because these methods are known, they will not be described in detail herein. In certain embodiments, the moisture content of the non-saturated lightweight aggregate may be determined by one or more sensors, such as via the non-limiting example of a microwave probe (not shown). In these and other embodiments, the weight percentage of fully or substantially fully saturated lightweight aggregate may be a known parameter, thereby making the volume of water needed to fully saturate a given quantity of aggregate relatively straightforward to calculate.

According to various embodiments, a valve 22 may be used to meter a flow of water from a supply source 21 into the vacuum vessel 15 until a first volume of water (not shown) has been delivered into the vacuum vessel 15. In certain embodiments, the supply line 23 into the vacuum vessel 15 may be sized to avoid the input of air into the vacuum vessel with the inflow of water, such that the vacuum level within the vacuum vessel 15 is not adversely impacted (e.g., reduced). In these and still other embodiments, it should be understood that the water drawn into the evacuated vacuum vessel 15 may generally seek to at least substantially fill the evacuated pores and interstitial spaces within the aggregate particles. In certain embodiments, after the passage of a desired period of time (e.g., 30 to 45 minutes), the lightweight aggregate particles according to various embodiments may be fully or at least substantially fully saturated with the first volume of water and may be ready to be discharged into the concrete mixer for the production of a batch of lightweight aggregate concrete mixture. In still other embodiments, the desired period of time may be greater than 45 minutes or less than 30 minutes, as required for a particular application and/or a desired degree of saturation.

The first volume of water provided via the supply source 21 and into the vacuum vessel 15 may according to various embodiments be maintained at a temperature substantially different than that of the aggregate likewise delivered into the vacuum vessel (e.g., via the storage bin 12). In certain embodiments, the water may be cooler in temperature than the aggregate, thereby cooling the overall concrete temperature upon mixing in the concrete mixer 30, as will be described in further detail below. In other embodiments, the water may be warmer in temperature than the aggregate, thereby heating the aggregate to a desired degree, as may be necessary for a particular application. In any of these and other envisioned embodiments, it should be appreciated by those of ordinary skill in the art that the temperature differential and/or the vacuum pressure within the vacuum vessel 15 should be configured so as to prevent any water in the vacuum vessel from boiling, as such would require substantially more expensive vacuum pump and tank systems. However, it should further be appreciated that in an alternative embodiment, such a degree of temperature differential may be desirable in accordance with the principles of the present invention.

Returning to FIG. 1, it may be understood that according to various embodiments, manipulation of a valve 26 will input a predetermined quantity of cement (not shown) from a bulk storage supply bin 25 into a concrete mixer 30, preferably simultaneously with the opening of a valve 27. In certain embodiments, the valve 27 may cooperate to discharge the fully or substantially saturated lightweight aggregate material from the vacuum vessel 15 and directly into the concrete mixer 30. In these and yet other envisioned embodiments, operation of valves 26 and 27 may thus provide two of the three necessary components for the production of a batch of lightweight aggregate concrete.

According to various embodiments, the third component necessary for the production of a batch of lightweight aggregate concrete is a second volume of water (not shown), which may serve to hydrate the dry cement (also not shown) within the concrete mixer 30. This second volume of water is in addition to the first volume of water (via the supply source 21) necessary, in accordance with certain embodiments, to fully (or alternatively, substantially) saturate the lightweight aggregate in the vacuum vessel 15. In various envisioned embodiments, it should be understood that the first volume of water from the supply source 21 is absorbed into the aggregate material in the vacuum vessel 15, thereby rendering it unavailable to hydrate the dry cement in the concrete mixer 30.

According to various embodiments, the second volume of water may be provided from the water supply 21, through an opening of the valve 22 to provide a supply of flush water to clean out the vacuum vessel 15 of the fully saturated or substantially fully saturated lightweight aggregate. In such embodiments, this second volume of water, utilized as flush water, can be discharged through the open valve 27 or added to the fully saturated or substantially fully saturated aggregate material within the vacuum vessel 15 before the aggregate is discharged into the concrete mixer 30. In alternatively envisioned embodiments, the second volume of water may be supplied from a source other than the water supply 21, as may be commonly known and understood to be feasible in the art.

The concrete mixer 30 according to various embodiments may then operated in a known manner to thoroughly mix the components of the fully saturated or substantially fully saturated lightweight aggregate, water, and cement, thereby producing a batch of lightweight aggregate concrete. One of ordinary skill in the art will recognize that additives, such as the non-limiting example of an air entrainment additive, may be added to the concrete mixer 30, in accordance with at least certain embodiments, before and/or during the mixing of the components to produce the batch of lightweight aggregate concrete. In other embodiments, no additives may be desirable and thus not included at this or other timeframes during the process.

In accordance with various envisioned embodiments, while the mixing of the components within the concrete mixer 30 is ongoing, the valve 27 may be closed to achieve a fully saturated or substantially fully saturated supply of a known quantity of lightweight aggregate. Upon closing of the valve 27, it should be understood that all or at least a portion of the process described above may be initiated and/or repeated; thereby providing a subsequent supply of fully saturated or substantially fully saturated lightweight aggregate for producing a subsequent batch of concrete. As will be appreciated by one of ordinary skill in the art, such a configuration according to various embodiments enables the process to be completed with heightened efficiencies and economies of scale.

One skilled in the art will recognize that conveyors, such as belt conveyors, drag conveyors, and augers, may often be used to convey materials such as aggregate and cement from a bulk supply bin to an operative apparatus, and such conveyors may be used within various embodiments of the above-described apparatus 10 and its accompanying process, as may be needed and/or appropriate for any of a variety of particular applications. The conveying of the fully saturated or substantially fully saturated aggregate according to these and yet other envisioned embodiments, however, needs to be minimized so that the saturation level of the lightweight aggregate is not deteriorated to the point that the advantages of the instant process are lost. In certain embodiments, exposure of the fully saturated or substantially fully saturated lightweight aggregate particles to the air and to the sun may cause significant evaporation of the moisture within the aggregate. Accordingly, the discharge of the fully saturated or substantially fully saturated lightweight aggregate particles from the vacuum vessel 15 to the concrete mixer 30 should, according to various envisioned embodiments, be as direct as possible given the constraints of equipment location and operation.

With the apparatus 10 according to various embodiments having been thus described above, the process of producing a batch of lightweight aggregate concrete according to the principles of the various embodiments of the apparatus may include the at least certain of the following steps, which will be described in further detail below:

A. providing supplies of water and cement in a manner that can be controlled and metered into appropriate apparatus 10, as well as a supply of non-saturated lightweight aggregate having properties of density and moisture content that are known or have definable parameters;

B. metering a known quantity of non-saturated lightweight aggregate from a bulk supply bin 12 into a vacuum vessel 15;

C. withdrawing air from the vacuum vessel 15 and from the pores and interstitial spaces within the lightweight aggregate particles by a vacuum pump 16;

D. maintaining a vacuum level within the vacuum vessel 15;

E. calculating a first volume of water needed to fully hydrate the known quantity of lightweight aggregate received within the confines of the vacuum vessel 15;

F. metering into the vacuum vessel 15 the first volume of water through a supply line 23 that may be sized to avoid the introduction of air into the vacuum vessel 15, and thus deteriorating the vacuum level being maintained;

G. exposing the evacuated lightweight aggregate particles to the supply of water for a sufficient period of time to achieve full or substantially full saturation of the lightweight aggregate particles;

I. directly discharging the fully saturated or substantially saturated lightweight aggregate particles from the vacuum vessel 15 into a concrete mixer 30 with a known fixed quantity of cement;

J. calculating a second volume of water that may be required to hydrate the known fixed quantity of cement placed into the concrete mixer 30;

K. adding a second supply of water to the vacuum vessel 15 to flush out the fully saturated or substantially fully saturated lightweight aggregate from the vacuum vessel 15 into the concrete mixer 30; and

L. operating the concrete mixer 30 to thoroughly mix the components received therein to produce a batch of lightweight aggregate concrete for subsequent discharge from the concrete mixer 30.

As described, according to various embodiments, while the concrete mixer 30 operates to thoroughly mix the components to produce the batch of lightweight aggregate concrete, the steps enumerated above to provide a subsequent fully saturated or substantially fully saturated supply of lightweight aggregate material may be repeated so that once the batch of produced concrete is discharged from the concrete mixer 30, the subsequent supply of fully saturated or substantially fully saturated lightweight aggregate is available to be added from the vacuum vessel 15 into the concrete mixer 30, thereby producing a subsequent batch of lightweight aggregate concrete.

In any of these and other envisioned embodiments, acquiring lightweight aggregate materials in a non-saturated state may enable significantly reduced shipping costs, as the weight of non-saturated aggregate is less than fully or nearly fully saturated aggregate. Furthermore, in certain embodiments, ancillary devices, such as watering bunkers, may not be necessary because the saturation of the aggregate may not be accomplished until the aggregate is actually needed for utilization in the concrete mixer 30. Thus, in accordance with various embodiments, the non-saturated lightweight aggregate may be stored in simple bulk material storage bin until being conveyed a relatively short distance and into the vacuum vessel 15. Also, the processes according to various embodiments of the present invention eliminate, or alternatively substantially minimize the need to have saturated aggregate particles continuously watered and monitored to prevent a significant reduction in the saturation level of the aggregate.

Further, in accordance with various embodiments, by utilizing fully saturated or substantially fully saturated lightweight aggregate particles in the production of lightweight aggregate concrete, the quality of the concrete so produced may be enhanced. In certain embodiments, the life of a fresh batch of lightweight aggregate concrete may be extended to any of a variety of desired degrees, provided adequate water is supplied at a subsequent time (e.g., upon demand) for the concrete batch and for fully or substantially fully saturating the lightweight aggregate.

According to various embodiments, due at least in part to the timing of the saturation process, tighter tolerances on the water to cement ratio for a given batch of lightweight aggregate concrete may be maintained with assurances of complete saturation of the lightweight aggregate. Further, the durability of the cured concrete mixture of certain embodiments is enhanced, due at least in part to an improved interfacial transition zone bonding between the cement and the lightweight aggregate. Likewise, the storage infrastructure necessary for maintaining water saturation of lightweight aggregates of known prior art processes is eliminated within various embodiments of the present invention, thereby resulting in lower material costs to produce lightweight aggregate concrete. In at least one embodiment, the concrete temperature during the plastic phase is reduced by eliminating the conversion of shear energy to heat.

The foregoing description of the various embodiments of the present invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. A method of producing a batch of lightweight aggregate concrete mixture, said method comprising the steps of:
vacuum saturating a quantity of substantially non-saturated lightweight aggregate to create a quantity of substantially saturated lightweight aggregate; and
discharging said quantity of substantially saturated lightweight aggregate into a concrete mixer to be combined with a quantity of cement and water to create lightweight aggregate concrete mixture.

2. The method of claim 1, wherein said step of vacuum saturating further includes the steps of:
conveying said quantity of said non-saturated lightweight aggregate from a supply bin of said non-saturated lightweight aggregate having known physical characteristics of density and moisture content into a vacuum vessel;
drawing a vacuum on said vacuum vessel to substantially evacuate air therefrom until a desired vacuum level has been achieved and is being substantially maintained;
calculating a first volume of water needed to substantially saturate said quantity of lightweight aggregate based upon at least a portion of said known physical characteristics thereof;
metering said first volume of water from a water supply into said vacuum vessel while said desired vacuum level is being substantially maintained; and
exposing said lightweight aggregate within said vacuum vessel to said first volume of water until said lightweight aggregate is substantially saturated.

3. The method of claim 2, wherein said step of calculating a first volume of water is performed substantially prior to said step of drawing a vacuum on said vacuum vessel.

4. The method of claim 2, wherein said step of drawing a vacuum on said vacuum vessel is performed substantially prior to said step of calculating a first volume of water.

5. The method of claim 2, wherein:
during said conveying step, said quantity of said substantially non-saturated lightweight aggregate is delivered at a first temperature;
during said metering step, said first volume of water is delivered at a second temperature, said second temperature being substantially different than said first temperature; and
during said of said exposing step, said quantity of said substantially non-saturated lightweight aggregate and said first volume of water each substantially reach a third temperature, said third temperature being substantially between each of said first and said second temperatures.

6. The method of claim 2, wherein said step of directly discharging further includes the step of discharging said substantially saturated lightweight aggregate into a concrete mixer without intermediate storage of said substantially saturated lightweight aggregate to be combined with said quantity of cement.

7. The method of claim 6, further comprising the steps of:
supplying a second volume of water from said water source for hydration of said quantity of cement; and
using said second volume of water as flush water to clean out any remaining particles of said substantially saturated lightweight aggregate remaining in said vacuum vessel and into said concrete mixer.

8. The method of claim 7, wherein said flush water is supplied to said vacuum vessel after said discharging step.

9. The method of claim 7, wherein said flush water is supplied to said vacuum vessel after said exposing step and before said discharging step.

10. The method of claim 7, wherein during said step of vacuum saturating, said substantially saturated lightweight aggregate is fully saturated by said first volume of water.

11. The method of claim 1, wherein during said step of vacuum saturating, said quantity of substantially non-saturated lightweight aggregate is fully saturated.

12. An apparatus for producing lightweight aggregate concrete, comprising:
a first supply bin for holding a quantity of non-saturated lightweight aggregate material;
a vacuum vessel in fluid communication with said first supply bin, said vacuum vessel configured to receive a predetermined quantity of non-saturated lightweight aggregate therefrom;
a vacuum pump operably coupled to said vacuum vessel, said vacuum pump configured to substantially withdraw air therefrom so as to establish a predetermined vacuum level at which air within pores and interstitial spaces within said lightweight aggregate material s is evacuated;
a water supply line coupled to said vacuum vessel, said water supply line configured for the inflow of a first volume of water into said vacuum vessel while said predetermined vacuum level is being substantially maintained to create a substantially saturated lightweight aggregate; and
a concrete mixer positioned to receive said substantially saturated lightweight aggregate substantially directly from said vacuum vessel.

13. The apparatus of claim 12, wherein:
said first supply bin is configured to deliver said quantity of said non-saturated lightweight aggregate at a first temperature;
said water supply line is configured to deliver said first volume of water at a second temperature, said second temperature being substantially different than said first temperature; and
said vacuum vessel is configured such that said quantity of said non-saturated lightweight aggregate and said first volume of water each substantially reach a third temperature when introduced into said vacuum vessel, said third temperature being between each of said first and said second temperatures.

14. The apparatus of claim 12, further comprising a second supply bin for holding a quantity of cement to be added to said concrete mixer with said substantially saturated lightweight aggregate.

15. The apparatus of claim 12, wherein said concrete mixer is positioned in sufficiently close proximity to said vacuum vessel that intermediate storage of said substantially saturated lightweight aggregate in unnecessary prior to the delivery of said aggregate to said concrete mixer.

16. The apparatus of claim 12, further comprising a conveyor configured to transfer said substantially saturated lightweight aggregate directly from said vacuum vessel to said concrete mixer.

17. The apparatus of claim 12, wherein each of said first supply bin, said water supply line and said vacuum pump are each connected to said vacuum vessel through at least one of a plurality of valves, said valves being configured to operatively seal said vacuum vessel.

18. The apparatus of claim 12, wherein said water supply line is sized to avoid an introduction of air into said vacuum vessel while said predetermined vacuum level is being maintained.

19. The apparatus of claim 12, wherein said water supply line is configured to provide a second volume of water to hydrate a predetermined quantity of cement added to said concrete mixer alongside said fully saturated lightweight aggregate to create a batch of lightweight aggregate concrete, such that said second volume of water flushes any remaining particles of said substantially saturated lightweight aggregate from said vacuum vessel and into said concrete mixer.

20. The apparatus of claim 12, wherein said vacuum vessel is configured to fully saturate said lightweight aggregate with said first volume of water.

21. A method of producing lightweight aggregate concrete, said method comprising the steps of:
providing respective supplies of water, cement and non-saturated lightweight aggregate, said lightweight aggregate having known physical characteristics of density and moisture content;
conveying a defined quantity of said non-saturated lightweight aggregate from said supply and into a vacuum vessel;
drawing a vacuum on said vacuum vessel to substantially evacuate air therefrom until a desired vacuum level has been achieved and is being substantially maintained;
calculating a first volume of water needed to substantially saturate said defined quantity of lightweight aggregate given said known physical characteristics thereof;
metering said first volume of water from said water supply into said vacuum vessel while said desired vacuum level is being substantially maintained;
exposing said lightweight aggregate within said vacuum vessel to said first volume of water until said lightweight aggregate is substantially saturated;
discharging said substantially saturated lightweight aggregate into a concrete mixer without intermediate storage of said fully saturated lightweight aggregate to be combined with a predetermined quantity of cement;
adding a second volume of water to said concrete mixer for hydration of said predetermined quantity of cement; and
mixing said fully saturated lightweight aggregate, said cement and said second volume of water in said concrete mixer to produce a batch of lightweight aggregate concrete.

22. The method of claim 21, wherein said step of calculating a first volume of water is performed substantially prior to said step of drawing a vacuum on said vacuum vessel.

23. The method of claim 21, wherein said step of drawing a vacuum on said vacuum vessel is performed substantially prior to said step of calculating a first volume of water.

24. The method of claim 21, wherein:
during said conveying step, said quantity of said non-saturated lightweight aggregate is delivered at a first temperature;
during said metering step, said first volume of water is delivered at a second temperature, said second temperature being substantially different than said first temperature; and
during said exposing step, said quantity of said non-saturated lightweight aggregate and said first volume of water each substantially reach a third temperature, said third temperature being between each of said first and said second temperatures.

25. The method of claim 21, wherein said adding step further comprises the steps of:
supplying said second volume of water from said water source; and
using said second volume of water as flush water to clean out said substantially saturated lightweight aggregate from said vacuum vessel before being added to said concrete mixer.

26. The method of claim 21, wherein said providing step establishes said supply of non-saturated lightweight aggregate in a bulk storage bin from which said non-saturated lightweight aggregate can be substantially conveyed to said vacuum vessel.

27. The method of claim 21, wherein said discharging step includes the step of directly transferring said substantially saturated lightweight aggregate into said concrete mixer.

28. The method of claim 27, wherein said step of directly transferring said substantially saturated lightweight aggregate utilizes a conveyor to transport said aggregate from said vacuum vessel to said concrete mixer.

29. The method of claim 21, wherein said step of drawing a vacuum on said vacuum vessel includes the steps of:
sealing said vacuum vessel from said respective supplies of water and non-saturated lightweight aggregate by closing each of a plurality of valves; and
activating a vacuum pump to evacuate the air from said vacuum vessel and from the pores within particles of said non-saturated lightweight aggregate.

30. The method of claim 21, wherein said metering step utilizes a water supply line that is sized to avoid any introduction of air into the vacuum vessel.

31. The method of claim 21, wherein said step of exposing said lightweight aggregate within said vacuum vessel to said first volume of water is performed until said lightweight aggregate is fully saturated.
